(19) United States
(12) Patent Application Publication
(10) Pub. No.: US 2008/0084408 A1
(43) Pub. Date: Apr. 10, 2008

(54) Gate driver, electro-optical device, electronic instrument, and drive method

(75) Inventor: Motoaki Nishimura, Fujimi-machi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/907,216

(22) Filed: Oct. 10, 2007

(30) Foreign Application Priority Data
Oct. 10, 2006 (JP) 2006-276049
Sep. 5, 2007 (JP) 2007-229712

(51) Int. Cl. G09G 5/00; G09G 3/36

(52) U.S. Cl. 345/205; 345/90

(57) ABSTRACT

A gate driver includes a first gate output circuit which outputs a select signal for selecting the first gate line, a second gate output circuit which outputs a select signal for selecting the second gate line in a select period subsequent to the select period of the first gate line, and a transistor as a first gate line short-circuiting circuit provided between outputs of the first and second gate output circuits. The transistor short-circuits the outputs of the first and second gate output circuits in a period between the select period of the first gate line and the select period of the second gate line.

Japanese Patent Application No. 2006-276049 filed on Oct. 10, 2006 and Japanese Patent Application No. 2007-229712 filed on Sep. 5, 2007, are hereby incorporated by reference in their entirety.

### BACKGROUND OF THE INVENTION

The present invention relates to a gate driver, an electro-optical device, an electronic instrument, a drive method and the like.

As a liquid crystal display (LCD) panel (display panel in a broad sense; electro-optical device in a broader sense) used for electronic instruments such as portable telephones, a simple matrix type LCD panel and an active matrix type LCD panel using a switching element such as a thin film transistor (hereinafter abbreviated as “TFT”) have been known.

The simple matrix method can easily reduce power consumption as compared with the active matrix method. On the other hand, it is difficult to increase the number of colors or display a video image using the simple matrix method. The active matrix method is suitable for increasing the number of colors or displaying a video image, but has difficulty in reducing power consumption.

The simple matrix type LCD panel and the active matrix type LCD panel are driven so that the polarity of the voltage applied to a liquid crystal (electro-optical material in a broad sense) forming a pixel is reversed alternately. As such an alternating drive method, line inversion drive and field inversion drive (frame inversion drive) have been known. In line inversion drive, the polarity of the voltage applied to the liquid crystal is reversed in units of one or more scan lines. In field inversion drive, the polarity of the voltage applied to the liquid crystal is reversed in field (frame) units.

In this case, the voltage level applied to a pixel electrode forming a pixel can be reduced by changing a common electrode voltage (common voltage) supplied to a common electrode provided opposite to the pixel electrode at the inversion drive timing.

However, power consumption increases accompanying charging/discharging the liquid crystal, even when using such an alternating drive method. In order to solve this problem, JP-A-2002-244622 discloses technology of reducing power consumption by initializing a charge stored in a liquid crystal to zero by short-circuiting two electrodes provided on either side of the liquid crystal during inversion drive, thereby causing the voltage to transition to the intermediate voltage before short-circuiting the electrodes, for example.

However, the technology disclosed in JP-A-2002-244622 has a problem in that the power consumption reduction effect varies depending on the voltage applied to the source line. Therefore, the effect of reducing the amount of charge by charging/discharging the common electrode, of which the polarity of the applied voltage is reversed, is insufficient. According to the technology disclosed in JP-A-2002-244622, the amount of charging/discharging may be increased by short-circuiting the electrodes provided on either side of the liquid crystal depending on the relationship between the voltage applied to the source line and the polarity of the common electrode voltage, whereby the effect of reducing power consumption may be impaired.

On the other hand, it is necessary to drive the gate line when driving the LCD panel. However, the technology disclosed in JP-A-2002-244622 cannot reduce power consumption accompanying driving the gate line. It is difficult to reduce power consumption by short-circuiting the gate line and the common electrode, differing from the case of short-circuiting the source line and the common electrode. Moreover, image quality deteriorates.

As described above, it is desirable to reduce power consumption accompanying driving the gate line in order to reduce power consumption to a certain extent.

### SUMMARY

According to one aspect of the invention, there is provided a gate driver that scans a first gate line and a second gate line of an electro-optical device, the gate driver comprising:

a first gate output circuit that outputs a first select signal to a first output, the first select signal selecting the first gate line in a first select period, the first gate line being selected during the first select period;

a second gate output circuit that outputs a second select signal to a second output, the second select signal selecting the second gate line in a second select period subsequent to the first select period, the second gate line being selected during the second select period; and

a first gate line short-circuiting circuit provided between the first output and the second output,

the first gate line short-circuiting circuit short-circuiting the first output and the second output in a period between the first select period and the second select period.

According to another aspect of the invention, there is provided an electro-optical device comprising:

a plurality of gate lines;

a plurality of source lines;

a plurality of pixels, each of the plurality of pixels being specified by a gate line among the plurality of gate lines and a source line among the plurality of source lines; and

the above gate driver which drives at least the first gate line and the second gate line.

According to a further aspect of the invention, there is provided an electro-optical device comprising:

a plurality of gate lines;

a plurality of source lines;

a plurality of pixels, each of the plurality of pixels being specified by a gate line among the plurality of gate lines and a source line among the plurality of source lines; and

a first gate line short-circuiting circuit provided between a first gate line among the plurality of gate lines and a second gate line among the plurality of gate lines, the second gate line being selected subsequently to the first gate line,

the first gate line short-circuiting circuit short-circuiting the first gate line and the second gate line in a period between a first select period and a second select period, the first gate line being selected during the first period, the second gate line being selected during the second period.

According to a further aspect of the invention, there is provided an electro-optical device comprising the above gate driver.

According to a further aspect of the invention, there is provided an electronic instrument comprising the above gate driver.

According to a further aspect of the invention, there is provided an electronic instrument comprising the above electro-optical device.

According to a further aspect of the invention, there is provided a drive method for scanning a first gate line and a second gate line of an electro-optical device, the method comprising:

outputting a first select signal that selects the first gate line in a first select period;

short-circuiting the first gate line and the second gate line in a period between the first select period and a second select period; and

outputting a second select signal that selects the second gate line in the second select period in a state in which the first gate line and the second gate line are electrically disconnected.

### BRIEF DESCRIPTION OF THE SEVERAL VIEWS OF THE DRAWING

FIG. 1 shows an example of a block diagram of a liquid crystal device according to one embodiment of the invention.

FIG. 2 is a block diagram showing a configuration example of a gate driver shown in FIG. 1.

FIG. 3 is a block diagram showing a configuration example of a source driver shown in FIG. 1.

FIG. 4 is a view showing a configuration example of a reference voltage generation circuit, a DAC, and a source line driver circuit shown in FIG. 3.

FIG. 5 is a block diagram showing a configuration example of a power supply circuit shown in FIG. 1.

FIG. 6 is a view showing an example of the drive waveform of a display panel shown in FIG. 1.

FIG. 7 is a view illustrative of polarity inversion drive according to one embodiment of the invention.

FIG. 8 is a view showing an example of the major portion of the configuration of a gate driver according to one embodiment of the invention.

FIG. 9 is a timing diagram showing an example of control signals of an output buffer shown in FIG. 8.

FIG. 10 is a view showing an example of the drive waveform of a gate driver according to one embodiment of the invention.

FIG. 11 is a block diagram showing another configuration example of a liquid crystal device according to a modification of one embodiment of the invention.

FIG. 12 is a block diagram showing a configuration example of an electronic instrument to which the gate driver according to one embodiment of the invention or its modification is applied.

### DETAILED DESCRIPTION OF THE EMBODIMENT

Aspects of the invention may provide a gate driver, an electro-optical device, an electronic instrument, and a drive method capable of reducing power consumption accompanying driving the gate line.

According to one embodiment of the invention, there is provided a gate driver that scans a first gate line and a second gate line of an electro-optical device, the gate driver comprising:

a first gate output circuit that outputs a first select signal to a first output, the first select signal selecting the first gate line in a first select period, the first gate line being selected during the first select period;

a second gate output circuit that outputs a second select signal to a second output, the second select signal selecting the second gate line in a second select period subsequent to the first select period, the second gate line being selected during the second select period; and

a first gate line short-circuiting circuit provided between the first output and the second output,

the first gate line short-circuiting circuit short-circuiting the first output and the second output in a period between the first select period and the second select period.

According to this embodiment, the level of the select signal can be changed by recycling a charge at the falling edge of the select signal of the first gate line and the rising edge of the select signal of the second gate line without external charging/discharging. This makes it possible to reduce the amount of charging/discharging when changing the voltages of the first and second gate lines, whereby power consumption accompanying driving the gate line can be reduced. As a result, power consumption can be necessarily reduced to a certain extent when driving the electro-optical device.

The gate driver according to this embodiment, each of the first gate output circuit and second gate output circuit may include:

a first switch circuit provided between an unselect voltage power supply line to which a gate line unselect voltage is supplied and the first output or the second output; and
a second switch circuit provided between a select voltage power supply line to which a gate line select voltage is supplied and the first output or the second output; and
one of the first switching circuit and the second switch circuit may be set in a conducting state after a period in which the first switching circuit and the second switch circuit are set in a nonconducting state.

The gate driver according to this embodiment,

the first gate line short-circuiting circuit may include a transistor, and the transistor may be gate-controlled so that the transistor is set in a conducting state in an unselect period of the first gate line and the second gate lines.

According to the above embodiment, power consumption can be reduced by recycling charge when driving the gate line using a simple configuration.

The gate driver according to this embodiment,

a grayscale signal may be written into a pixel selected by the first gate line at a timing at which a voltage of the first gate line changes to a low-potential-side voltage after a short-circuiting period of the first output and the second output.

According to this embodiment, since the voltage at the timing at which the voltage of the first gate line changes to the low-potential-side voltage is written into the pixel selected by the first gate line, deterioration in image quality can be prevented, even if the pixel select periods overlap by short-circuiting the first and second gate lines.

According to another embodiment of the invention, there is provided an electro-optical device comprising:

a plurality of gate lines;

a plurality of source lines;

a plurality of pixels, each of the plurality of pixels being specified by a gate line among the plurality of gate lines and a source line among the plurality of source lines; and

the above gate driver which drives at least the first gate line and the second gate line.

According to a further embodiment of the invention, there is provided an electro-optical device comprising:

a plurality of gate lines;

a plurality of source lines;

a plurality of pixels, each of the plurality of pixels being specified by a gate line among the plurality of gate lines and a source line among the plurality of source lines; and

a first gate line short-circuiting circuit provided between a first gate line among the plurality of gate lines and a second gate line among the plurality of gate lines, the second gate line being selected subsequently to the first gate line,

the first gate line short-circuiting circuit short-circuiting the first gate line and the second gate line in a period between a first select period and a second select period, the first gate line being selected during the first period, the second gate line being selected during the second period.

The electro-optical device according to this embodiment,

the first gate line short-circuiting circuit may include a transistor, the transistor may be gate-controlled so that the transistor is set in a conducting state in an unselect period of the first gate line and in an unselected period of the second gate line.

The electro-optical device according to this embodiment,

a grayscale signal may be written into a pixel selected by the first gate line at a timing at which a voltage of the first gate line changes to a low-potential-side voltage after a short-circuiting period of the first gate line and the second gate line.

The electro-optical device according to this embodiment may further comprise:

a first gate output circuit that outputs a first select signal to a first output, the first select signal selecting the first gate line in a first select period, the first gate line being selected during the first select period; and

a second gate output circuit that outputs a second select signal to a second output, the second select signal selecting the second gate line in a second select period subsequent to the first select period, the second gate line being selected during the second select period.

The electro-optical device according to this embodiment may further comprise a source driver that supplies a grayscale signal to the plurality of source lines.

According to a further embodiment of the invention, there is provided an electro-optical device comprising the above gate driver.

According to the above embodiment, the level of the select signal can be changed by recycling charge at the falling edge of the select signal of the first gate line and the rising edge of the select signal of the second gate line without external charging/discharging. This makes it possible to reduce the amount of charging/discharging when changing the voltages of the first and second gate lines, whereby power consumption accompanying driving the gate line can be reduced. As a result, an electro-optical device can be provided which can necessarily reduce power consumption to a certain extent.

According to a further embodiment of the invention, there is provided an electronic instrument comprising the above gate driver.

According to a further embodiment of the invention, there is provided an electronic instrument comprising the above electro-optical device.

According to the above embodiment, an electro-optical device can be provided which can necessarily reduce power consumption to a certain extent by recycling charge when driving the gate line.

According to a further embodiment of the invention, there is provided a drive method for scanning a first gate line and a second gate line of an electro-optical device, the method comprising:

outputting a first select signal that selects the first gate line in a first select period;

short-circuiting the first gate line and the second gate line in a period between the first select period and a second select period; and

outputting a second select signal that selects the second gate line in the second select period in a state in which the first gate line and the second gate line are electrically disconnected.

The drive method according to this embodiment,

a grayscale signal may be written into a pixel selected by the first gate line at a timing at which a voltage of the first gate line changes to a low-potential-side voltage after the short-circuiting the first gate line and the second gate line in a period between the first select period and the second select period.

The embodiments of the invention are described below in detail with reference to the drawings. Note that the embodiments described below do not in any way limit the scope of the invention laid out in the claims. Note that all elements of the embodiments described below should not necessarily be taken as essential requirements for the invention.

1. Liquid Crystal Device

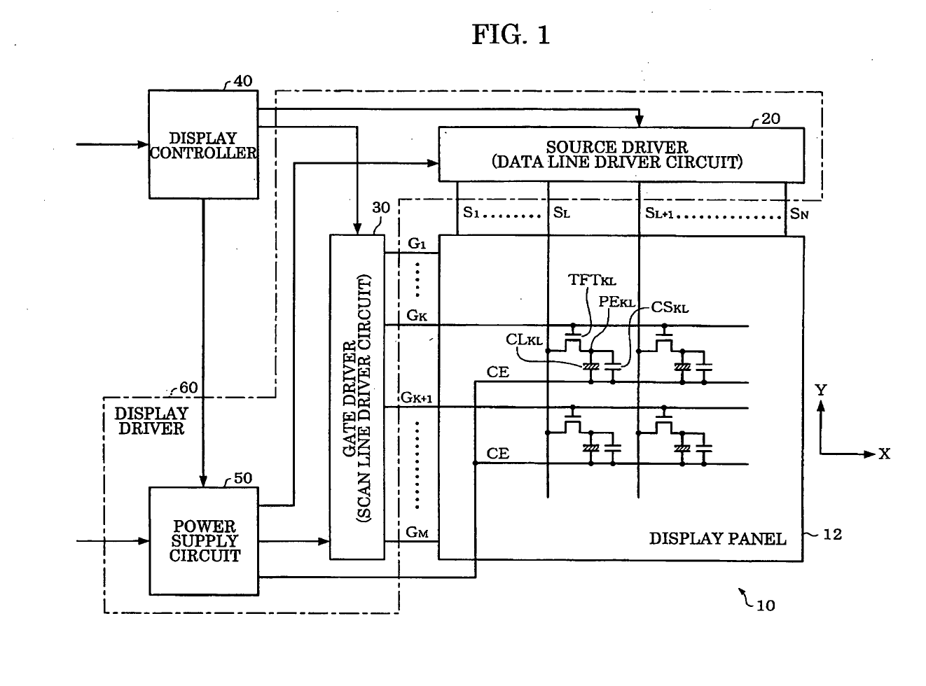

FIG. 1 shows an example of a block diagram of a liquid crystal device according to this embodiment.

A liquid crystal device 10 (liquid crystal display device; display device in a broad sense) includes a display panel 12 (liquid crystal panel or liquid crystal display (LCD) panel in a narrow sense), a source driver 20 (data line driver circuit in a broad sense), a gate driver 30 (scan line driver circuit in a broad sense), a display controller 40, and a power supply circuit 50. The liquid crystal device 10 need not necessarily include all of these circuit blocks. The liquid crystal device 10 may have a configuration in which some of these circuit blocks are omitted.

The display panel 12 (electro-optical device in a broad sense) includes gate lines (scan lines in a broad sense), source lines (data lines in a broad sense), and pixels specified by the gate lines and the source lines. In this case, an active matrix type liquid crystal device may be formed by connecting a thin film transistor (TFT; switching element in a broad sense) with the source line and connecting the pixel electrode with the TFT.

Specifically, the display panel 12 is an amorphous silicon liquid crystal panel in which an amorphous silicon thin film is formed on an active matrix substrate (e.g. glass substrate). Gate lines G₁ to G_{M} (M is a positive integer equal to or larger than two), arranged in a direction Y in FIG. 1 and extending in a direction X, and source lines S₁ to S_{N} (N is a positive integer equal to or larger than two), arranged in the direction X and extending in the direction Y, are disposed on the active matrix substrate. A thin film transistor TFT_{KL} (switching element in a broad sense) is provided at a position corresponding to the intersection of the gate line G_{K} (I≦K≦M, K is a positive integer) and the source line S_{L} (1≦L≦N, L is a positive integer). A gate electrode of the thin film transistor TFT_{KL} is connected with the gate line G_{K}, a source electrode of the thin film transistor TFT_{KL} is connected with the source line S_{L}, and a drain electrode of the thin film transistor TFT_{KL} is connected with a pixel electrode PE_{KL}. A liquid crystal capacitor CL_{KL} (liquid crystal element) and a storage capacitor CS_{KL} are formed between the pixel electrode PE_{KL} and a common electrode CE opposite to the pixel electrode PE_{KL} through a liquid crystal (electro-optical material in a broad sense). The liquid crystal is sealed between the active matrix substrate provided with the thin film transistor TFT_{KL}, the pixel electrode PE_{KL}, and the like and a common substrate provided with the common electrode CE. The transmissivity of the pixel changes depending on the voltage applied between the pixel electrode PE_{KL} and the common electrode CE.

The voltage level of a common electrode voltage VCOM (high-potential-side voltage VCOMH and low-potential-side voltage VCOML) applied to the common electrode CE is generated by a common electrode voltage generation circuit included in the power supply circuit 50. The common electrode CE is formed over the entire common substrate, for example.

The source driver 20 drives the source lines S₁ to S_{N} of the display panel 12 based on grayscale data. The gate driver 30 scans (sequentially drives) the gate lines G₁ to G_{M} of the display panel 12.

The display controller 40 controls the source driver 20, the gate driver 30, and the power supply circuit 50 according to information set by a host (not shown) such as a central processing unit (CPU). Specifically, the display controller 40 sets the operation mode of the source driver 20 and the gate driver 30 or supplies the vertical synchronization signal and the horizontal synchronization signal generated therein to the source driver 20 and the gate driver 30, and controls the power supply circuit 50 relating to the polarity inversion timing of the voltage level of the common electrode voltage VCOM applied to the common electrode CE, for example.

The power supply circuit 50 generates various voltage levels (grayscale voltages) necessary for driving the display panel 12 and the voltage level of the common electrode voltage VCOM of the common electrode CE based on a reference voltage supplied from the outside.

In the liquid crystal device 10 having such a configuration, the source driver 20, the gate driver 30, and the power supply circuit 50 cooperate to drive the display panel 12 based on grayscale data supplied from the outside under control of the display controller 40.

In FIG. 1, a display driver 60 may be formed as a semiconductor device (integrated circuit (IC)) by integrating the source driver 20, the gate driver 30, and the power supply circuit 50.

In FIG. 1, the display driver 60 may include the display controller 40. In FIG. 1, the display driver 60 may be a semiconductor device in which the source driver 20 or the gate driver 30 and the power supply circuit 50 are integrated.

1.1 Gate Driver

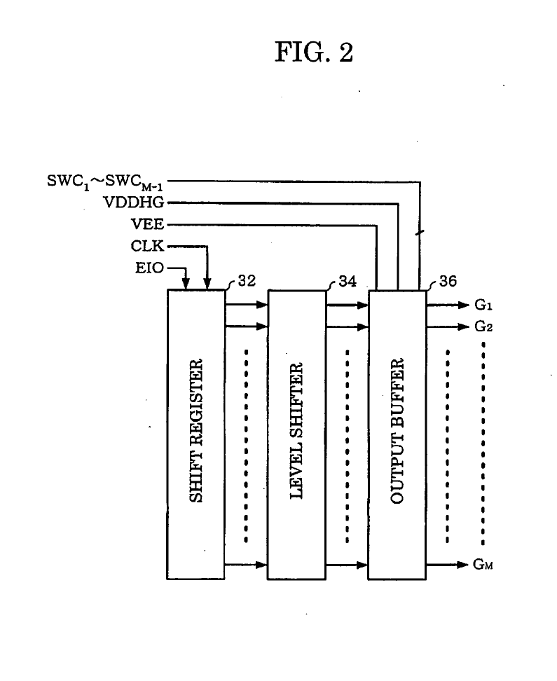

FIG. 2 shows a configuration example of the gate driver 30 shown in FIG. 1.

The gate driver 30 includes a shift register 32, a level shifter 34, and an output buffer 36.

The shift register 32 includes flip-flops provided corresponding to the gate lines and sequentially connected. The shift register 32 holds an enable input-output signal EIO in the flip-flop in synchronization with a clock signal CLK, and sequentially shifts the enable input-output signal EIO to the adjacent flip-flops in synchronization with the clock signal CLK. The enable input-output signal EIO input to the shift register 32 is the vertical synchronization signal supplied from the display controller 40.

The level shifter 34 shifts the voltage level from the shift register 32 to the voltage level corresponding to the liquid crystal element of the display panel 12 and the transistor capability of the TFT. Since a high voltage level is required as the above voltage level, a high voltage process differing from other logic circuit sections is used for the level shifter 34.

The output buffer 36 buffers a scan voltage (select signal) shifted by the level shifter 34, and drives the gate line by outputting the scan voltage to the gate line. The scan voltage is either an unselect voltage or a select voltage.

The output buffer 36 of the gate driver 30 according to this embodiment can reduce power consumption accompanying driving the gate line by recycling a charge when driving at least the gate lines G₁ and G₂ as first and second gate lines.

This embodiment illustrates an example in which the gate lines are scanned by shifting the enable input-output signal EIO using the shift register 32. Note that this embodiment is not limited thereto. For example, the gate driver 30 may include an address decoder and select the gate line based on the decoding result of the address decoder.

1.2 Source Driver

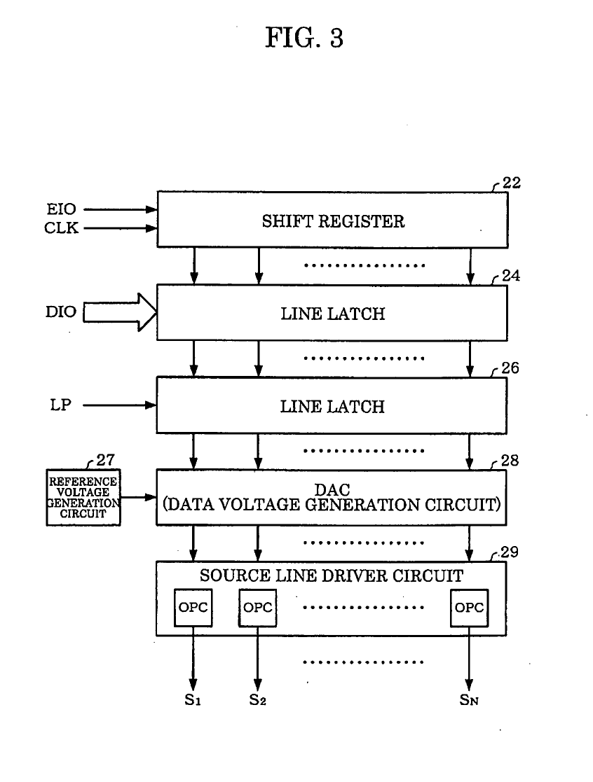

FIG. 3 is a block diagram showing a configuration example of the gate driver 20 shown in FIG. 1.

The source driver 20 includes a shift register 22, line latches 24 and 26, a reference voltage generation circuit 27, a digital-to-analog converter (DAC) 28 (data voltage generation circuit in a broad sense), and a source line driver circuit 29.

The shift register 22 includes flip-flops provided corresponding to the source lines and sequentially connected. The shift register 22 holds the enable input-output signal EIO in synchronization with the clock signal CLK, and sequentially shifts the enable input-output signal EIO to the adjacent flip-flops in synchronization with the clock signal CLK.

Grayscale data (DIO) is input to the line latch 24 from the display controller 40 in units of 18 bits (6 bits (grayscale data)×3 (each color of RGB)), for example. The line latch 24 latches the grayscale data (DIO) in synchronization with the enable input-output signal EIO sequentially shifted by each flip-flop of the shift register 22.

The line latch 26 latches the grayscale data of one horizontal scan latched by the line latch 24 in synchronization with a horizontal synchronization signal LP supplied from the display controller 40.

The reference voltage generation circuit 27 generates 64 (=26) reference voltages. The 64 reference voltages generated by the reference voltage generation circuit 27 are supplied to the DAC 28.

The DAC 28 (data voltage generation circuit) generates an analog data voltage supplied to each source line. Specifically, the DAC 28 selects one of the reference voltages from the reference voltage generation circuit 27 based on the digital grayscale data from the line latch 26, and outputs an analog data voltage corresponding to the digital grayscale data.

The source line driver circuit 29 buffers the data voltage from the DAC 28, and drives the source line by outputting the data voltage to the source line. Specifically, the source line driver circuit 29 includes voltage-follower-connected operational amplifiers OPC (impedance conversion circuits in a broad sense) provided in source line units. The operational amplifier circuit OPC subjects the data voltage from the DAC 28 to impedance conversion and outputs the resulting data voltage to the source line.

FIG. 3 employs a configuration in which the digital grayscale data is subjected to digital-analog conversion and output to the source line through the source line driver circuit 29. Note that a configuration may also be employed in which an analog image signal is sampled/held and output to the source line through the source line driver circuit 29.

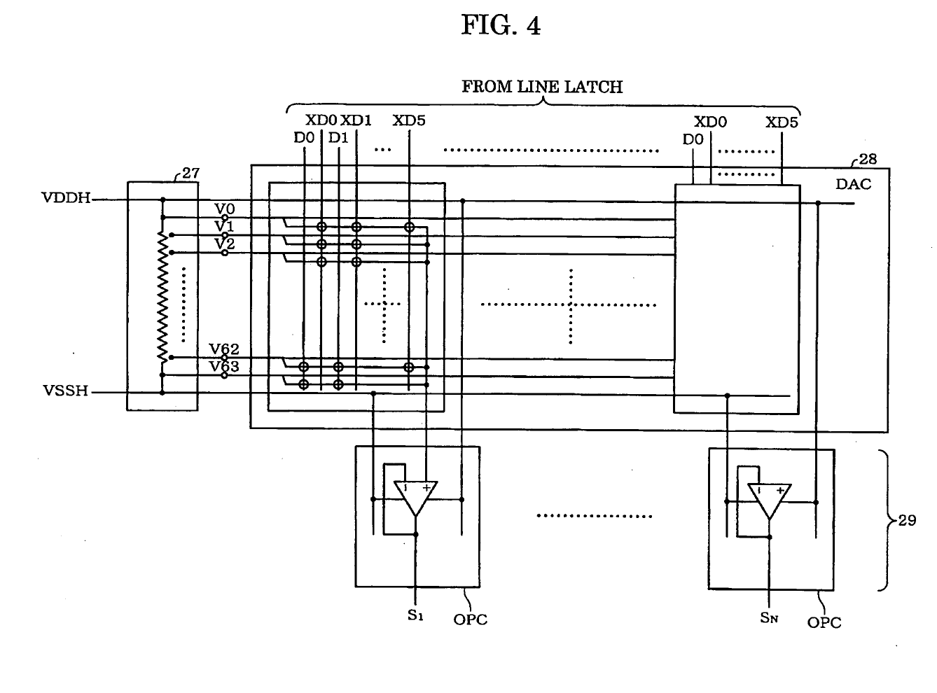

FIG. 4 shows a configuration example of the reference voltage generation circuit 27, the DAC 28, and the source line driver circuit 29 shown in FIG. 3. In FIG. 4, the grayscale data is made up of 6-bit data D0 to D5, and inversion data of each bit of the grayscale data is indicated by XD0 to XD5. In FIG. 4, the same sections as in FIG. 3 are indicated by the same symbols. Description of these sections is appropriately omitted.

The reference voltage generation circuit 27 generates 64 reference voltages by dividing the voltage between voltages VDDH and VSSH using resistors. The reference voltages respectively correspond to grayscale values indicated by the six-bit grayscale data The reference voltage is supplied in common to the source lines S₁ to S_{N}.
The DAC 28 includes decoders provided in source line units. The decoder outputs the reference voltage corresponding to the grayscale data to the operational amplifier OPC.

1.3 Power Supply Circuit

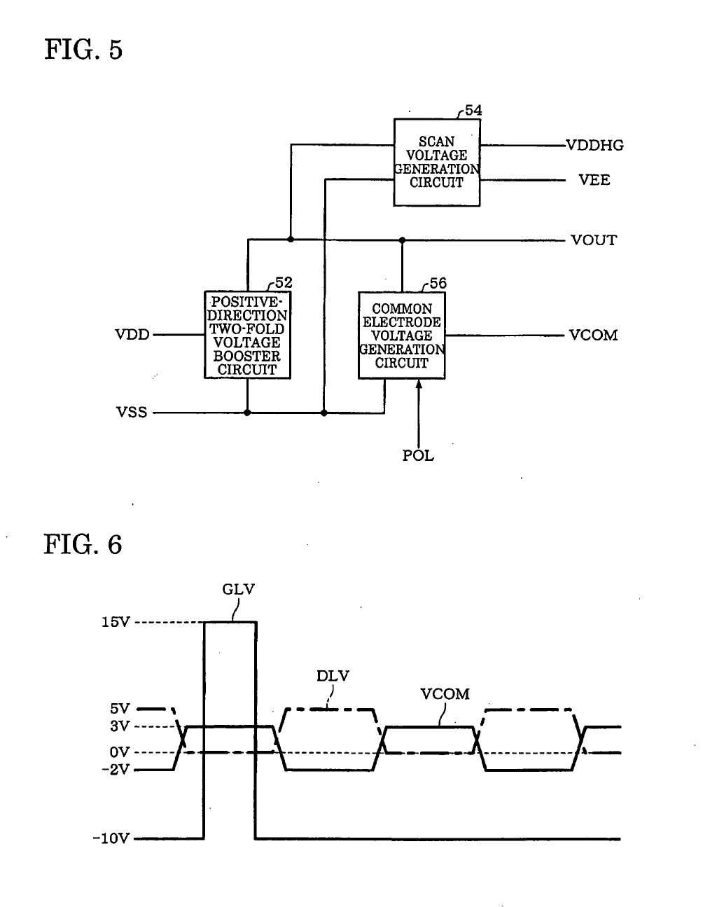

FIG. 5 shows a configuration example of the power supply circuit 50 shown in FIG. 1.

The power supply circuit 50 includes a positive-direction two-fold voltage booster circuit 52, a scan voltage generation circuit 54, and a common electrode voltage generation circuit 56. A system ground power supply voltage VSS and a system power supply voltage VDD are supplied to the power supply circuit 50.

The system ground power supply voltage VSS and the system power supply voltage VDD are supplied to the positive-direction two-fold voltage booster circuit 52. The positive-direction two-fold voltage booster circuit 52 generates a power supply voltage VOUT obtained by increasing the system power supply voltage VDD in the positive direction by a factor of two with respect to the system ground power supply voltage VSS. Specifically, the positive-direction two-fold voltage booster circuit 52 boosts the difference between the system ground power supply voltage VSS and the system power supply voltage VDD by a factor of two. The positive-direction two-fold voltage booster circuit 52 may be formed using a known charge-pump circuit. The power supply voltage VOUT is supplied to the source driver 20, the scan voltage generation circuit 54, and the common electrode voltage generation circuit 56. It is preferable that the positive-direction two-fold voltage booster circuit 52 output the power supply voltage VOUT obtained by boosting the system power supply voltage VDD in the positive direction by a factor of two by boosting the system power supply voltage VDD by a factor of two or more and adjusting the voltage level using a regulator.

The system ground power supply voltage VSS and the power supply voltage VOUT are supplied to the scan voltage generation circuit 54. The scan voltage generation circuit 54 generates a scan voltage. The scan voltage is a voltage applied to the gate line driven by the gate driver 30. The high-potential-side voltage and the low-potential-side voltage of the scan voltage are voltages VDDHG and VEE, respectively.

The common electrode voltage generation circuit 56 generates the common electrode voltage VCOM. The common electrode voltage generation circuit 56 outputs the high-potential-side voltage VCOMH or the low-potential-side voltage VCOML as the common electrode voltage VCOM based on a polarity inversion signal POL. The polarity inversion signal POL is generated by the display controller 40 in synchronization with the polarity inversion timing.

2. Drive Waveform

FIG. 6 shows an example of the drive waveforms of the display panel 12 shown in FIG. 1.

A grayscale voltage DLV corresponding to the grayscale value of grayscale data is applied to the source line. In FIG. 6, the grayscale voltage DLV has an amplitude of 5 V with respect to the system ground power supply voltage VSS (=0 V).

A scan voltage GLV at the low-potential-side voltage VEE (=−10 V) is applied to the gate line as an unselect voltage in an unselected state, and a scan voltage GLV at the high-potential-side voltage VDDHG (=15 V) is applied to the gate line as a select voltage in a selected state.

The common electrode voltage VCOM at the high-potential-side voltage VCOMH (=3 V) or the low-potential-side voltage VCOML (=−2 V) is applied to the common electrode CE. The polarity of the voltage level of the common electrode voltage VCOM is reversed with respect to a given voltage in synchronization with the polarity inversion timing. FIG. 6 shows the waveform of the common electrode voltage VCOM during scan line inversion drive. The polarity of the grayscale voltage DLV applied to the source line is also reversed with respect to a given voltage in synchronization with the polarity inversion timing.

A liquid crystal element deteriorates when a direct-current voltage is applied for a long period of time. This makes it necessary to employ a drive method in which the polarity of the voltage applied to the liquid crystal element is reversed in units of specific periods. As such a drive method, frame inversion drive, scan (gate) line inversion drive, data (source) line inversion drive, dot inversion drive, and the like can be given.

Frame inversion drive reduces power consumption, but results in an insufficient image quality. Data line inversion drive and dot inversion drive provide an excellent image quality, but require a high voltage for driving a display panel.

This embodiment employs scan line inversion drive, for example. In scan line inversion drive, the polarity of the voltage applied to the liquid crystal element is reversed in units of scan periods (scan lines). For example, a positive voltage is applied to the liquid crystal element in the first scan period (scan line), a negative voltage is applied to the liquid crystal element in the second scan period, and a positive voltage is applied to the liquid crystal element in the third scan period. In the subsequent frame, a negative voltage is applied to the liquid crystal element in the first scan period, a positive voltage is applied to the liquid crystal element in the second scan period, and a negative voltage is applied to the liquid crystal element in the third scan period.

In scan line inversion drive, the polarity of the voltage level of the common electrode voltage VCOM applied to the common electrode CE is reversed in units of scan periods.

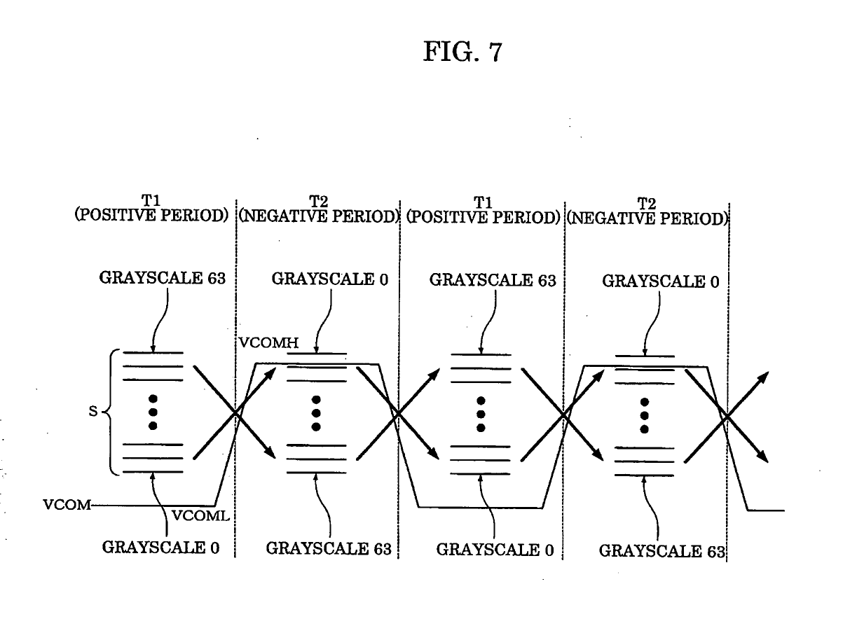

As shown in FIG. 7, the voltage level of the common electrode voltage VCOM is set at the low-potential-side voltage VCOML in a positive period T1 (first period) and is set at the high-potential-side voltage VCOMH in a negative period T2 (second period). The polarity of the grayscale voltage applied to the source line is also reversed at the above timing. The low-potential-side voltage VCOML is a voltage level obtained by reversing the polarity of the high-potential-side voltage VCOMH with respect to a given voltage level.

The positive period T1 is a period in which the voltage level of the pixel electrode to which the grayscale voltage is supplied through the source line becomes higher than the voltage level of the common electrode CE. In the period T1, a positive voltage is applied to the liquid crystal element. The negative period T2 is a period in which the voltage level of the pixel electrode to which the grayscale voltage is supplied through the source line becomes lower than the voltage level of the common electrode CE. In the period T2, a negative voltage is applied to the liquid crystal element.

The voltage necessary for driving the display panel can be reduced by thus reversing the polarity of the common electrode voltage VCOM. This makes it possible to reduce the withstand voltage of the driver circuit, whereby the driver circuit manufacturing process can be simplified and the manufacturing cost can be reduced.

3. Features of this Embodiment

According to this embodiment, power consumption accompanying driving the gate line can be reduced by causing the gate driver 30 to recycle a charge. The major portion of the configuration of the gate driver 30 is described below.

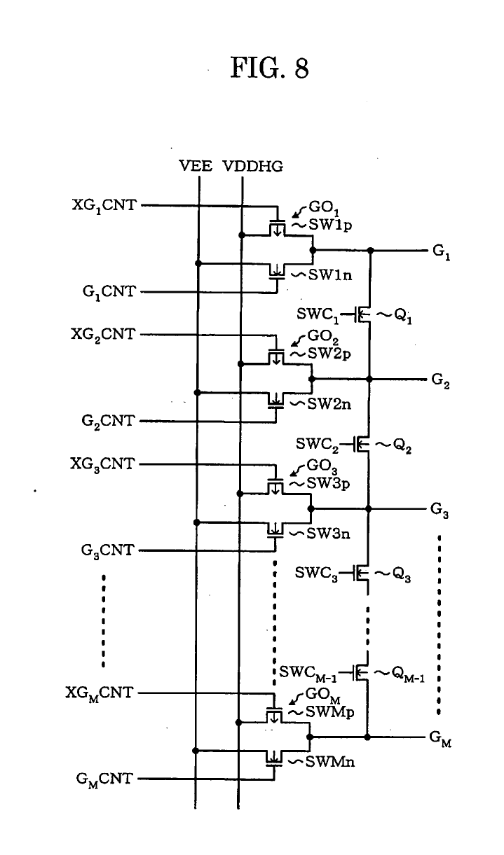

FIG. 8 shows an example of the major portion of the configuration of the gate driver 30 according to this embodiment. FIG. 8 is a circuit diagram showing a configuration example of the output buffer 36 shown in FIG. 2.

The output buffer 36 includes gate output circuits provided in gate line units.

A gate output circuit GO₁ (first gate output circuit) which outputs the scan voltage to the gate line G₁ includes an n-type (second conductivity type) metal-oxide-semiconductor (MOS) transistor SW1n as a first switch circuit, and a p-type (first conductivity type) MOS transistor SW1p as a second switch circuit. An unselect voltage power supply line to which the voltage VEE (gate line unselect voltage) is supplied is connected with the source of the transistor SW1n. The drain of the transistor SW1n is connected with the output node of the gate output circuit GO₁. A control signal G₁CNT is supplied to the gate of the transistor SW1n. A select voltage power supply line to which the voltage VDDHG (gate line select voltage) is supplied is connected with the source of the transistor SW1p. The drain of the transistor SW1p is connected with the output node of the gate output circuit GO₁. A control signal XG₁CNT is supplied to the gate of the transistor SW1p. The control signals G₁CNT and XG₁CNT are generated so that the transistors SW1n and SW1p are not turned ON at the same time. The control signals G₁CNT and XG₁CNT are supplied to the output buffer 36 from the level shifter 34, or generated in the output buffer 36.

Likewise, a gate output circuit GO₂ (second gate output circuit) which outputs the scan voltage to the gate line G₂ includes an n-type MOS transistor SW2n as a first switch circuit, and a p-type MOS transistor SW2p as a second switch circuit. The unselect voltage power supply line to which the voltage VEE (gate line unselect voltage) is supplied is connected with the source of the transistor SW2n. The drain of the transistor SW2n is connected with the output node of the gate output circuit GO₂. A control signal G₂CNT is supplied to the gate of the transistor SW2n. The select voltage power supply line to which the voltage VDDHG (gate line select voltage) is supplied is connected with the source of the transistor SW2p. The drain of the transistor SW2p is connected with the output node of the gate output circuit GO₂. A control signal XG₂CNT is supplied to the gate of the transistor SW2p. The control signals G₂CNT and XG₂CNT are generated so that the transistors SW2n and SW2p are not turned ON at the same time. The control signals G₂CNT and XG₂CNT are supplied to the output buffer 36 from the level shifter 34, or generated in the output buffer 36.

Gate output circuits GO₃ to GOₘ have the same configuration as the gate output circuit GO₁.

The output buffer 36 further includes n-type MOS transistors Q₁ to Q_{M-1} as first to (M−1)th gate line short-circuiting circuits. The transistor Q₁ as the first gate line short-circuiting circuit is provided between the output of the gate output circuit GO₁ and the output (output node) of the gate output circuit GO₂. Specifically, the source (drain) of the transistor Q₁ is connected with the output of the gate output circuit GO₁, and the drain (source) of the transistor Q₁ is connected with the output of the gate output circuit GO₂. A control signal SWC₁, is supplied to the gate of the transistor Q₁. Likewise, the transistor Q₂ as the second gate line short-circuiting circuit is provided between the output of the gate output circuit GO₂ and the output of the gate output circuit GO₃. Specifically, the source (drain) of the transistor Q₂ is connected with the output of the gate output circuit GO₂, and the drain (source) of the transistor Q₂ is connected with the output of the gate output circuit GO₃. A control signal SWC₂ is supplied to the gate of the transistor Q₂. Likewise, the transistor Q_{M-1} as the (M−1)th gate line short-circuiting circuit is provided between the output of the gate output circuit GO_{M-1} and the output of the gate output circuit GO_{M}, for example.

The transistor Q₁ as the first gate line short-circuiting circuit short-circuits the outputs of the gate output circuits GO₁ and GO₂ in a period between the select period of the gate line G₁ (first gate line) and the select period of the gate line G₂ (second gate line). Likewise, the transistor Q₂ as the second gate line short-circuiting circuit short-circuits the outputs of the gate output circuits GO₂ and GO₃ in a period between the select period of the gate line G₂ and the select period of the gate line G₃. Specifically, the transistor Qⱼ (1≦j≦M−1, j is an integer) short-circuits the outputs of the gate output circuits GOⱼ and GOⱼ₊₁ in a period between the select period of the gate line Gⱼ and the select period of the gate line Gⱼ₊₁.

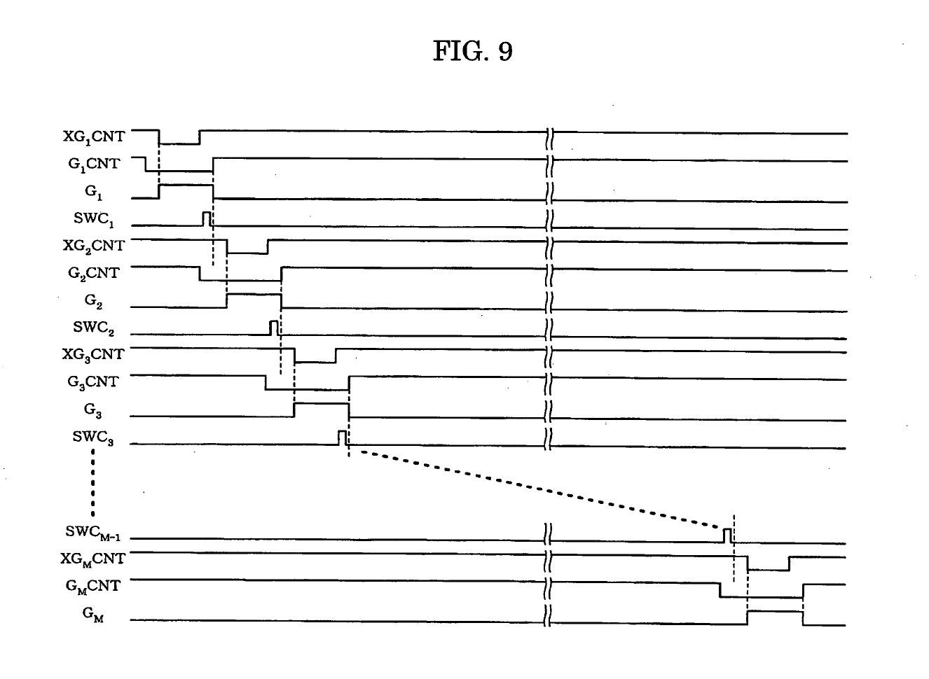

FIG. 9 is a timing diagram showing an example of the control signals of the output buffer 36 shown in FIG. 8.

When focusing on the gate output circuit GO₁, the voltage VEE (unselect voltage) is output to the gate line G₁ when the control signal G₁CNT is set at the H level. When the control signal G₁CNT is then set at the L level, the control signal XG₁CNT changes from the H level to the L level after a specific OFF-OFF period has expired. When the control signal XG₁CNT is set at the L level, the voltage VDDHG (select voltage) is output to the gate line G₁. After the control signal XG₁CNT has been set at the H level, the control signal G₁CNT changes from the L level to the H level after a specific OFF-OFF period has expired. This causes the voltage VEE (unselect voltage) to be output to the gate line G₁. The control signal SWC₁ has a pulse in the OFF-OFF period. The control signal SWC₁ is generated by the output buffer 36 (gate output circuit GO₁) based on the control signals G₁CNT and XG₁CNT, for example.

When focusing on the gate output circuit GO₂, the control signal G₂CNT changes from the H level to the L level immediately before the commencement of the OFF-OFF period of the gate lines G₁ and G₂. The control signal XG₂CNT changes from the H level to the L level after the OFF-OFF period has expired. When the control signal XG₂CNT is set at the L level, the voltage VDDHG (select voltage) is output to the gate line G₂. Since a charge is recycled between the gate lines G₁ and G₂ using the control signal SWC₁, the gate line G₂ is set at a voltage higher in potential than the voltage VEE immediately before the select period of the gate line G₂. Specifically, the transistor Q₁ as the first gate line short-circuiting circuit is gate-controlled so that the transistor Q₁ is set in a conducting state in the unselect period of the gate lines G₁ and G₂ as the first and second gate lines. After short-circuiting the gate lines G₁ and G₂, a select signal for selecting the gate line G₂ is output in the select period of the gate line G₂ in a state in which the gate lines G₁ and G₂ are electrically disconnected. This reduces the amount of external charging/discharging of the gate line G₂. After the control signal XG₂CNT has been set at the H level, the control signal G₂CNT changes from the L level to the H level after a specific OFF-OFF period has expired. This causes the voltage VEE (unselect voltage) to be output to the gate line G₂. The control signal SWC₂ has a pulse in the OFF-OFF period. The control signal SWC₂ is generated by the output buffer 36 (gate output circuit GO₂) based on the control signals G₂CNT and XG₂CNT, for example.

When focusing on the gate output circuit GO₃, the control signal G₃CNT changes from the H level to the L level immediately before the commencement of the OFF-OFF period of the gate lines G₂ and G₃. The control signal XG₃CNT changes from the H level to the L level after the OFF-OFF period has expired. When the control signal XG₃CNT is set at the L level, the voltage VDDHG (select voltage) is output to the gate line G₃. Since a charge is recycled between the gate lines G₂ and G₃ using the control signal SWC₂, the gate line G₃ is set at a voltage higher in potential than the voltage VEE immediately before the select period of the gate line G₃. Specifically, the transistor Q₂ as the second gate line short-circuiting circuit is gate-controlled so that the transistor Q₂ is set in a conducting state in the unselect period of the gate lines G₂ and G₃ as the second and third gate lines. After short-circuiting the gate lines G₂ and G₃, a select signal for selecting the gate line G₃ is output in the select period of the gate line G₃ in a state in which the gate lines G₂ and G₃ are electrically disconnected. This reduces the amount of external charging/discharging of the gate line G₃. After the control signal XG₃CNT has been set at the H level, the control signal G₃CNT changes from the L level to the H level after a specific OFF-OFF period has expired. This causes the voltage VEE (unselect voltage) to be output to the gate line G₃. The control signal SWC₃ has a pulse in the OFF-OFF period. The control signal SWC₃ is generated by the output buffer 36 (gate output circuit GO₃) based on the control signals G₃CNT and XG₃CNT, for example.

The above description also applies to the gate output circuits GO₄ to GO_{M}.

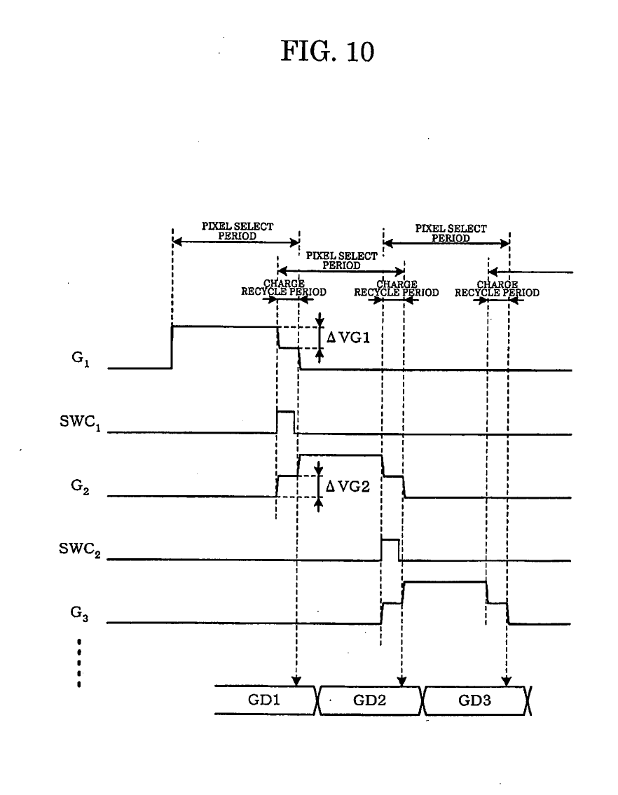

FIG. 10 shows an example of the drive waveforms of the gate driver 30 according to this embodiment.

In a charge recycle period in which the control signals SWC₁ to SWC_{M-1} are set at the H level, two gate lines are set at the same potential by the transistors Q₁ to Q_{M-1} as the gate line short-circuiting circuits which are set in a conducting state by the control signals SWC₁ to SWC_{M-1}, respectively.

Specifically, after the select signal of the gate line G₁ has been set at the H level, the control signal SWC₁ is set at the H level, whereby the gate lines G₁ and G₂ are short-circuited. As a result, the gate line G₁ and the gate line G₂ are set at the same potential. The control signal SWC₁ is then set at the L level, and the select signal set at the H level is output to the gate line G₂. This enables the voltage of the gate line G₁ to be changed by delta VG1 from the potential of the voltage VDDHG to the potential after short-circuiting the gate lines G₁ and G₂ in the charge recycle period without externally charging/discharging the gate line G₁. The voltage of the gate line G₂ can be changed by delta VG2 from the potential of the voltage VEE to the potential after short-circuiting the gate lines G₁ and G₂ in the charge recycle period without externally charging/discharging the gate line G₂. This reduces the amount of charging/discharging when changing the voltages of the gate lines G₁ and G₂, whereby power consumption can be reduced.

The period between the timing at which the voltage of the gate line G₁ changes from the voltage VEE to the voltage VDDHG and the timing at which the gate line G₁ is again set at the voltage VEE is the pixel select period of the gate line G₁. The timing at which the gate line G₁ is again set at the voltage VEE is the timing when a given OFF-OFF period has expired after the completion of the short-circuiting period of the gate lines G₁ and G₂. Since the TFT of the pixel is set in a conducting state by the voltage of the gate line, the voltage of the source line at the timing at which the voltage of the gate line G₁ changes to the voltage VEE (low-potential-side voltage) after the short-circuiting period of the gate lines G₁ and G₂ is written into the pixel electrode of the pixel selected by the gate line G₁. Specifically, in order to write the grayscale voltage into the pixel electrode of the pixel selected by the gate line G₁, the source driver 20 must hold the grayscale voltage corresponding to the grayscale data GD₁ at least until a given OFF-OFF period expires after the completion of the short-circuiting period of the gate lines G₁ and G₂. This prevents deterioration in image quality, even if the pixel select periods overlap by short-circuiting the gate lines G₁ and G₂.

Likewise, after the select signal of the gate line G₂ has been set at the H level, the control signal SWC₂ is set at the H level, whereby the gate lines G₂ and G₃ are short-circuited. As a result, the gate line G₂ and the gate line G₃ are set at the same potential. The control signal SWC₂ is then set at the L level, whereby the select signal set at the H level is output to the gate line G₃. This enables the voltage of the gate line G₂ to be changed by delta VG1 from the potential of the voltage VDDHG to the potential after short-circuiting the gate lines G₂ and G₃ in the charge recycle period without externally charging/discharging the gate line G₂. The voltage of the gate line G₃ can be changed by delta VG2 from the potential of the voltage VEE to the potential after short-circuiting the gate lines G₂ and G₃ in the charge recycle period without externally charging/discharging the gate line G₃. This reduces the amount of charging/discharging when changing the voltages of the gate lines G₂ and G₃, whereby power consumption can be reduced.

The period between the timing at which the voltage of the gate line G₂ changes from the voltage VEE to the voltage VDDHG and the timing at which the gate line G₂ is again set at the voltage VEE is the pixel select period of the gate line G₂. The timing at which the gate line G₂ is again set at the voltage VEE is a timing when a given OFF-OFF period has expired after the completion of the short-circuiting period of the gate lines G₂ and G₃. Since the TFT of the pixel is set in a conducting state by the voltage of the gate line, the voltage of the source line at the timing at which the voltage of the gate line G₂ changes to the voltage VEE (low-potential-side voltage) after the short-circuiting period of the gate lines G₂ and G₃ is written into the pixel electrode of the pixel selected by the gate line G₂. Specifically, in order to write the grayscale voltage into the pixel electrode of the pixel selected by the gate line G₂, the source driver 20 must hold the grayscale voltage corresponding to the grayscale data GD₂ at least until a given OFF-OFF period expires after the completion of the short-circuiting period of the gate lines G₂ and G₃. This prevents deterioration in image quality, even if the pixel select periods overlap by short-circuiting the gate lines G₂ and G₃.

A charge is also recycled for the gate lines G₃ to G_{M} in the same manner as described above.

According to this embodiment, the level of the select signal can be changed by recycling charge at the falling edge of the select signal of the gate line G₁, the rising and falling edges of the select signals of the gate lines G₂ to G_{M-1} and the rising edge of the select signal of the gate line G_{M} without external charging/discharging, as described above. This reduces the amount of charging/discharging when changing the voltages of the gate lines G₁ and G_{M} whereby power consumption can be reduced.

4. Modification

In this embodiment, the liquid crystal device 10 includes the display controller 40, as shown in FIG. 1. Note that the display controller 40 may be provided outside the liquid crystal device 10. Alternatively, the host may be provided in the liquid crystal device 10 together with the display controller 40. Some or all of the source driver 20, the gate driver 30, the display controller 40, and the power supply circuit 42 may be formed on the display panel 12. Alternatively, only the transistors Q₁ to Q_{M-1} of the output buffer 36 of the gate driver 30 as the first to (M−1)th gate line short-circuiting circuits may be provided on the display panel 12, and other circuits of the output buffer 36 of the gate driver 30 may be provided outside the display panel 12.

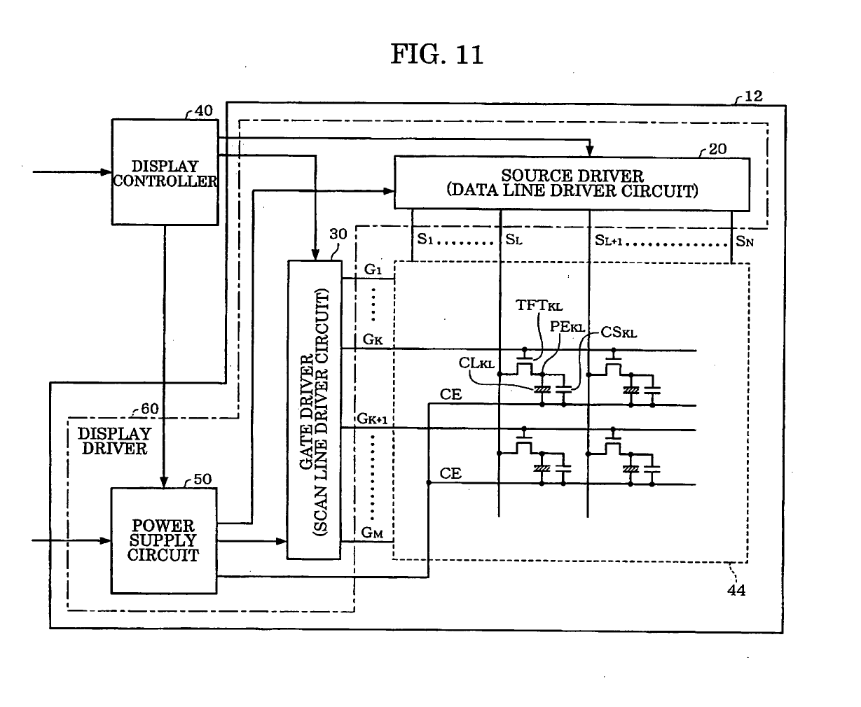

FIG. 11 is a block diagram showing another configuration example of the liquid crystal device according to a modification of this embodiment.

In FIG. 11, the same sections as in FIG. 1 are indicated by the same symbols. Description of these sections is appropriately omitted. In this modification, the display driver 60 including the source driver 20, the gate driver 30, and the power supply circuit 50 is formed on the display panel 12 (panel substrate). Specifically, the display panel 12 may be configured to include gate lines, source lines, pixels (pixel electrodes) connected with the gate lines and the source lines, a source driver which drives the source lines, and a gate driver which scans the gate lines. The pixels are formed in a pixel formation region 44 of the display panel 12. Each pixel may include a TFT of which the source is connected with the source line and the gate is connected with the gate line, and a pixel electrode connected with the drain of the TFT. In FIG. 11, at least one of the gate driver 30 and the power supply circuit 50 may not be provided on the display panel 12.

5. Electronic Instrument

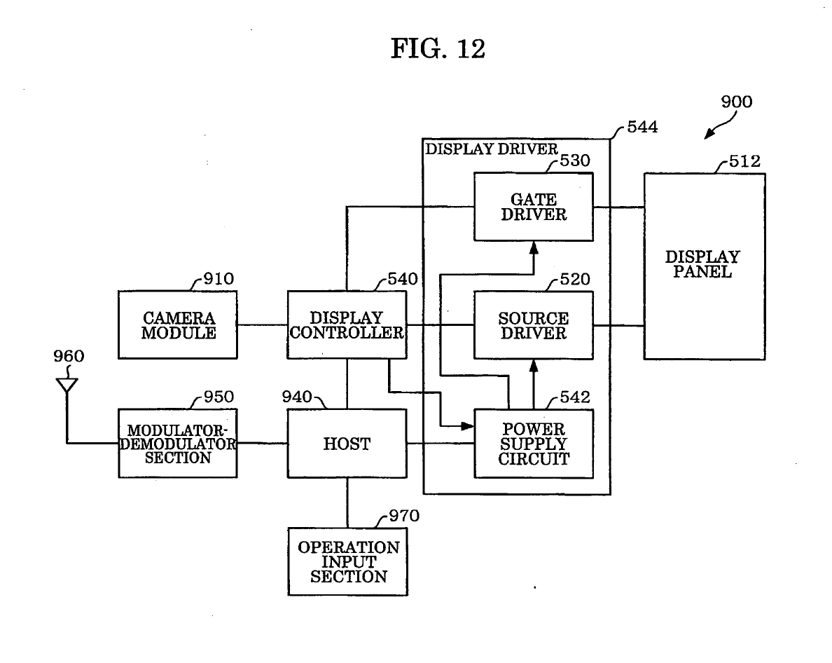

FIG. 12 is a block diagram showing a configuration example of an electronic instrument to which the gate driver according to this embodiment or its modification is applied. FIG. 12 is a block diagram showing a configuration example of a portable telephone as the electronic instrument.

A portable telephone 900 includes a camera module 910. The camera module 910 includes a CCD camera, and supplies image data obtained by the CCD camera to a display controller 540 in a YUV format. The display controller 540 has the function of the display controller 40 shown in FIG. 1 or 11.

The portable telephone 900 includes a display panel 512. The display panel 512 is driven by a source driver 520 and a gate driver 530. The display panel 512 includes gate lines, source lines, and pixels. The display panel 512 has the function of the display panel 12 shown in FIG. 1 or 11.

The display controller 540 is connected with the source driver 520 and the gate driver 530, and supplies grayscale data in an RGB format to the source driver 520.

A power supply circuit 542 is connected with the source driver 520 and the gate driver 530, and supplies drive power supply voltages to the source driver 520 and the gate driver 530. The power supply circuit 542 has the function of the power supply circuit 50 shown in FIG. 1 or 11. The portable telephone 900 includes the source driver 520, the gate driver 530, and the power supply circuit 542 as a display driver 544. The display driver 544 drives the display panel 512.

A host 940 is connected with the display controller 540. The host 940 controls the display controller 540. The host 940 demodulates grayscale data received via an antenna 960 using a modulator-demodulator section 950, and supplies the demodulated grayscale data to the display controller 540. The display controller 540 causes the source driver 520 and the gate driver 530 to display an image on the display panel 512 based on the grayscale data. The source driver 520 has the function of the source driver 20 shown in FIG. 1 or 11. The gate driver 530 has the function of the gate driver 30 shown in FIG. 1 or 11.

The host 940 modulates grayscale data generated by the camera module 910 using the modulator-demodulator section 950, and directs transmission of the modulated data to another communication device via the antenna 960.

The host 940 transmits and receives grayscale data, captures an image using the camera module 910, and displays an image on the display panel 512 based on operation information from an operation input section 970.

Although only some embodiments of the invention have been described above in detail, those skilled in the art would readily appreciate that many modifications are possible in the embodiments without materially departing from the novel teachings and advantages of the invention. Accordingly, such modifications are intended to be included within the scope of the invention. For example, the invention may be applied not only to drive the above liquid crystal display panel, but also to drive an electroluminescent display device, a plasma display device, and the like.

Some of the requirements of any claim of the invention may be omitted from a dependent claim which depends on that claim. Some of the requirements of any independent claim of the invention may be allowed to depend on any other independent claim.

What is claimed is:

1. A gate driver that scans a first gate line and a second gate line of an electro-optical device, the gate driver comprising:
a first gate output circuit that outputs a first select signal to a first output, the first select signal selecting the first gate line in a first select period, the first gate line being selected during the first select period;
a second gate output circuit that outputs a second select signal to a second output, the second select signal selecting the second gate line in a second select period subsequent to the first select period, the second gate line being selected during the second select period; and
a first gate line short-circuiting circuit provided between the first output and the second output,
the first gate line short-circuiting circuit short-circuiting the first output and the second output in a period between the first select period and the second select period.

2. The gate driver as defined in claim 1,
each of the first gate output circuit and second gate output circuit including:
a first switch circuit provided between an unselect voltage power supply line to which a gate line unselect voltage is supplied and the first output or the second output; and
a second switch circuit provided between a select voltage power supply line to which a gate line select voltage is supplied and the first output or the second output; and
one of the first switch circuit and the second switch circuit being set in a conducting state after a period in which the first switch circuit and the second switch circuit are set in a nonconducting state.

3. The gate driver as defined in claim 1,
the first gate line short-circuiting circuit including a transistor, the transistor being gate-controlled so that the transistor is set in a conducting state in an unselect period of the first gate line and the second gate line.

4. The gate driver as defined in claim 1,
a grayscale signal being written into a pixel selected by the first gate line at a timing at which a voltage of the first gate line changes to a low-potential-side voltage after a short-circuiting period of the first output and the second output.

5. An electro-optical device comprising:
a plurality of gate lines;
a plurality of source lines;
a plurality of pixels, each of the plurality of pixels being specified by a gate line among the plurality of gate lines and a source line among the plurality of source lines; and
the gate driver as defined in claim 1 which drives at least the first gate line and the second gate line.

6. An electro-optical device comprising:
a plurality of gate lines;
a plurality of source lines;
a plurality of pixels, each of the plurality of pixels being specified by a gate line among the plurality of gate lines and a source line among the plurality of source lines; and
a first gate line short-circuiting circuit provided between a first gate line among the plurality of gate lines and a second gate line among the plurality of gate lines, the second gate line being selected subsequently to the first gate line,
the first gate line short-circuiting circuit short-circuiting the first gate line and the second gate line in a period between a first select period and a second select period, the first gate line being selected during the first period, the second gate line being selected during the second period.

7. The electro-optical device as defined in claim 6,
the first gate line short-circuiting circuit including a transistor, the transistor being gate-controlled so that the transistor is set in a conducting state in an unselect period of the first gate line and in an unselected period of the second gate line.

8. The electro-optical device as defined in claim 6,
a grayscale signal being written into a pixel selected by the first gate line at a timing at which a voltage of the first gate line changes to a low-potential-side voltage after a short-circuiting period of the first gate line and the second gate line.

9. The electro-optical device as defined in claim 5, further comprising:
a first gate output circuit that outputs a first select signal to a first output, the first select signal selecting the first gate line in a first select period, the first gate line being selected during the first select period; and
a second gate output circuit that outputs a second select signal to a second output, the second select signal selecting the second gate line in a second select period subsequent to the first select period, the second gate line being selected during the second select period.

10. The electro-optical device as defined in claim 6, further comprising:
a first gate output circuit that outputs a first select signal to a first output, the first select signal selecting the first gate line in a first select period, the first gate line being selected during the first select period; and
a second gate output circuit that outputs a second select signal to a second output, the second select signal selecting the second gate line in a second select period subsequent to the first select period, the second gate line being selected during the second select period.

11. The electro-optical device as defined in claim 5, further comprising a source driver that supplies a grayscale signal to the plurality of source lines.

12. The electro-optical device as defined in claim 6, further comprising a source driver that supplies a grayscale signal to the plurality of source lines.

13. An electro-optical device comprising the gate driver as defined in claim 1.

14. An electronic instrument comprising the gate driver as defined in claim 1.

15. An electronic instrument comprising the electro-optical device as defined in claim 5.

16. An electronic instrument comprising the electro-optical device as defined in claim 6.

17. A drive method for scanning a first gate line and a second gate line of an electro-optical device, the method comprising:
outputting a first select signal that selects the first gate line in a first select period;
short-circuiting the first gate line and the second gate line in a period between the first select period and a second select period; and
outputting a second select signal that selects the second gate line in the second select period in a state in which the first gate line and the second gate line are electrically disconnected.

18. The drive method as defined in claim 17,
a grayscale signal being written into a pixel selected by the first gate line at a timing at which a voltage of the first gate line changes to a low-potential-side voltage after the short-circuiting the first gate line and the second gate line in a period between the first select period and the second select period.
